(19) United States
(12) Patent Application Publication
(10) Pub. No.: US 2026/0172458 A1
(43) Pub. Date: Jun. 18, 2026

(54) EVENT GROUP COLLABORATION SESSION FOR MEETING ORGANIZERS

(71) Applicant: MICROSOFT TECHNOLOGY LICENSING, LLC, Redmond, WA (US)

(72) Inventors: Yichen JIA, Kirkland, WA (US); Xonatia Ravelle LEE, Brooklyn, NY (US); Kirsten Allyson RUE, Seattle, WA (US)

(21) Appl. No.: 18/986,247

(22) Filed: Dec. 18, 2024

(51) Int. Cl. H04L 65/401; H04L 51/04; H04L 51/212; H04L 51/216

(52) U.S. Cl. CPC H04L 65/4015; H04L 51/04; H04L 51/212; H04L 51/216

(57) ABSTRACT

The disclosed techniques provide event group collaboration sessions for meeting organizers. An event group collaboration session can include a private chat session that is exclusively reserved for meeting organizers or other users with designated roles, such as presenters. The private chat session is provided to allow organizers to collaborate before a meeting, and the private chat session is not shared with audience members of the meeting. A system also provides tools that allow meeting organizers and other select users to readily access the private chat session from the meeting or from user interfaces that are used in the setup of the meeting. This allows the organizers to readily access a contextually relevant thread directly from a meeting without having to provide a number of manual steps to navigate to a separate thread. A system uses two meeting objects and a data structure relating the objects to control messages threads.

### BACKGROUND

There are a number of different types of collaborative systems that allow users to communicate. For example, some existing systems allow people to collaborate by sharing content using video streams, audio streams, shared files, chat messages, etc. For example, a number of people can concurrently share live video streams to simulate an in-person meeting environment. This allows people to verbally communicate their ideas while also allowing them to communicate non-verbal gestures. A communication session, e.g., an on-line meeting, can have a definitive start time and end time and have a predetermined attendee list with each person having specific roles. The start time and end time are referred to herein as properties of the first communication session, the “main meeting” or “first meeting.”

Although there are several different types of systems that allow users to collaborate, some systems still have a number of shortcomings. For example, when an on-line meeting is organized by two or more people, e.g., a group of planners and presenters, some existing systems do not provide an easy way for that group of people to have a private communication session that focuses on a particular event. Although communication systems do allow those users to set up a private chat session, that universal chat session may make it difficult for that group of users to focus on one particular meeting, as a universal chat session can be used for many other projects and tasks. In particular, the use of a universal chat session may be very difficult for meeting planners, especially when they have to plan and organize a large number of meetings.

Alternatively, instead of using a universal chat session, meeting organizers could use the chat thread that is provided in the meeting they are organizing. The use of that thread would help keep an individual conversation for the planning of that particular meeting separate from other threads that are used for planning to other meetings. However, one issue with this approach is that all of the attendees would be inundated with all of the messages that pertain to the setup process, which would greatly distract the attendees from focusing on the meeting content itself. This can be an issue particularly in meetings where there are hundreds or thousands of general audience attendees. This would also be an issue for users that are using mobile devices with limited screen space. When a meeting chat thread includes messages pertaining to the planning process of a meeting, such messages may keep the general audience from seeing important meeting content, but this also causes audience members to be disengaged and ignore notifications and important content.

### SUMMARY

The disclosed techniques provide event group collaboration sessions for meeting organizers. An event group collaboration session can include a private chat session that is reserved for meeting organizers or other users with designated roles, such as presenters. The private chat session is provided to allow organizers to collaborate before a meeting, and the private chat session is not shared with general audience members of the meeting, which allows the general audience to focus on meeting content. A system also provides tools that allow meeting organizers and other select users to readily access the private chat session from the meeting or from user interfaces that are used in the setup of the meeting. This allows the organizers to readily access a contextually relevant thread directly from a meeting without having to provide a number of manual steps to navigate to a separate thread.

In some embodiments, when an event, e.g., an on-line meeting, is scheduled with roles designated for the attendees, a system automatically generates a first meeting object for the event, a second meeting object for the event group collaboration session, and a data structure that associates the two meeting objects. The second meeting object only includes select members from the event, which can include a selection of certain people such as the event organizers and presenters who are scheduled to speak at the event. The second meeting object is also referred to herein as an “event-prep group object,” and the select members for the second meeting object are referred to herein as “prep group members.” The two meeting objects and the data structure are used to generate two user interface (UI) manifestations: one as an independent chat in each prep group member's UI, and the other accessible in the actual event UI.

The disclosed techniques provide a number of technical improvements over existing systems. As stated above, if an existing system uses a meeting chat thread for discussions on setting up that meeting, those messages can cause distractions to general attendees. This can lead to a number of unrelated messages that will cause users to ignore the messages. In addition, a large number of unrelated notifications will be invoked. This may lead to a number of notifications with diminishing relevancy. This also gives reason for people to ignore such notifications. Such inequities can discourage user engagement and reduce the efficacy of a meeting. Software applications that do not promote user engagement can lead to production loss and inefficiencies with respect to computing resources. For instance, participants of a communication session may need to refer to recordings or other resources when content is missed or overlooked because of a lack of user engagement. Content may need to be re-sent when users miss salient points during a live meeting. Some users may resort to the use of phones or other systems to communicate. For example, some users may send text messages or emails to other participants while in a conference call if a cue is missed, or if a number of people did not get a chance to speak, etc. Such manual steps can be disruptive to a person's workflow and highly inefficient when it comes to helping a person establish a collaboration protocol with a group of people. Such drawbacks of existing systems can lead to loss of productivity as well as inefficient use of computing resources.

The above-described activities can lead to inefficient use of a network, processor, memory, or other computing resources, especially when information is sent in duplicate or when messages from separate networks are needed to share missed content. Also, when a participant's level of engagement is negatively impacted during a meeting, such a loss of production may cause a need for prolonged meetings or follow-up meetings, which in turn take additional computing resources. Such production loss and inefficiencies with respect to computing resources can be exacerbated when a system is used to provide a collaborative environment for a large number of participants.

The disclosed techniques of controlled use of meeting threads also provide a technical benefit by improving user interactions with devices, especially small-screen devices. The disclosed features overcome the existing technical problems in that users can use small screen devices to participate in a meeting and remain informed with targeted, relevant messages instead of requiring general audience members to navigate through a large number of messages that are directed to meeting organizers. This is particularly helpful with small screen devices in that the screen is not overly populated with unrelated messages that distract users from viewing meeting content.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a system that provides event group collaboration sessions for meeting organizers.

FIG. 2 shows an event meeting object defining roles and identities of individual users that are part of a meeting.

FIG. 3 shows the generation of a prep-group meeting object that only includes a subset of users each having particular roles in the meeting.

FIG. 4 shows the generation of a data structure that associates the event meeting object with the prep-group meeting object.

FIG. 5 shows a UI that is generated for the event-prep group, the UI having a private chat thread that only allows a subset of users to view and communicate messages.

FIG. 6 shows an example of a second UI that is displayed to users that are not in the subset of users, the second UI displaying a thread for the main meeting.

FIG. 7A shows an example of an access UI that is displayed to the subset of users for providing access to the private chat thread reserved for the subset of users.

FIG. 7B shows a display of a UI that includes the private chat thread reserved for the subset of users in response to an input to the access UI.

FIG. 8A shows an example of a second access UI that is displayed to the subset of users, the second access UI having a calendar view for providing access to the private chat thread reserved for the subset of users.

FIG. 8B shows a display of a UI that includes the private chat thread reserved for the subset of users in response to an input to the second access UI.

FIG. 9A shows an example of a UI that is displayed exclusively to the subset of users during a main meeting, the UI having a tab that is selected for showing the main meeting chat thread.

FIG. 9B shows an example of a UI that is displayed exclusively to the subset of users during a main meeting, the UI having a tab that is selected for showing the private chat thread.

FIG. 10 shows an example of a UI that is displayed to any member of the main meeting, the UI showing the main meeting chat thread.

FIG. 11 shows a data structure that is used for accessing permissions of a meeting object.

FIG. 12 is a flow diagram showing aspects of a routine for implementing the disclosed techniques.

FIG. 13 is a diagram illustrating a distributed computing environment capable of implementing aspects of the techniques and technologies presented herein.

FIG. 14 is a computer architecture diagram illustrating a computing device architecture for a computing device capable of implementing aspects of the techniques and technologies presented herein.

### DETAILED DESCRIPTION

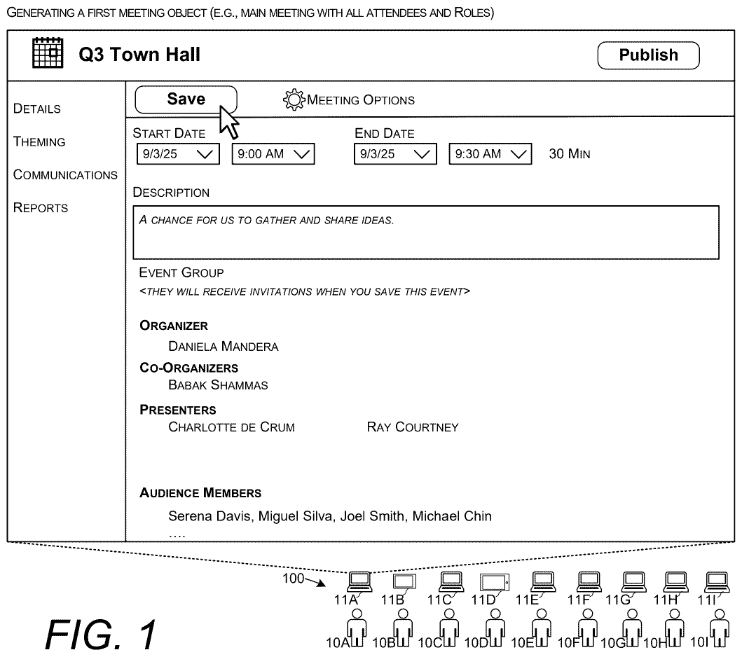

FIG. 1 illustrates a system 100 that provides event group collaboration sessions for meeting organizers. An event group collaboration session can include a private chat session that is exclusively reserved for meeting organizers or other users with designated roles, such as presenters. The private chat session is provided to allow organizers to collaborate before a meeting, and the private chat session is not shared with broader audience members of the meeting. A system also provides tools that allow meeting organizers and other select users to readily access the private chat session from a meeting user interface or from user interfaces that are used in the setup of the meeting. This allows the organizers to readily access a contextually relevant thread directly from a meeting without having to provide a number of manual steps to navigate to a separate thread. A system uses two meeting objects and a data structure relating the objects to control messages threads.

In the example of FIG. 1, there are a number of users in a meeting, where User 1 10A, Daniela Mandera, is associated with a computing device 11A, User 2 10B, Babak Shammas, is associated with another computing device 11A, User 3 10C, Charlotte De Crum, is associated with another computing device 11C, and User 4 10D, Ray Courtney, is associated with yet another computing device 11D, and other users 10E-10I are associated with other corresponding devices 11E-11L, each user including Serena Davis, Miguel Silva, Joel Smith, Michael Chin, and Freddy Chen. The first and second users are designated as meeting organizers, the third and fourth users are designated as presenters, and the other users are designated as audience members.

FIG. 1 through FIG. 4 illustrate an example of a process where the system is used to generate a meeting object for an event, e.g., the Q3 Town Hall event. The system then uses the first meeting object to automatically generate a second meeting object for the event-prep group, which only includes a subset of the users, who each have predetermined roles for the meeting. In this particular example, the predetermined roles include meeting organizers and presenters. The system then generates a data structure the links the first meeting object and the second meeting object. As described in more detail below, the system utilizes the data structure and the two meeting objects to display and control access to message threads associated with each meeting object. The process described below is executed by a computing system for controlling permissions for a first meeting object and a second meeting object. The first meeting object is used for managing access of a first communication session, which in this example is the “main meeting” and the second meeting object is used for managing access of a second communication session, e.g., the prep-group meeting.

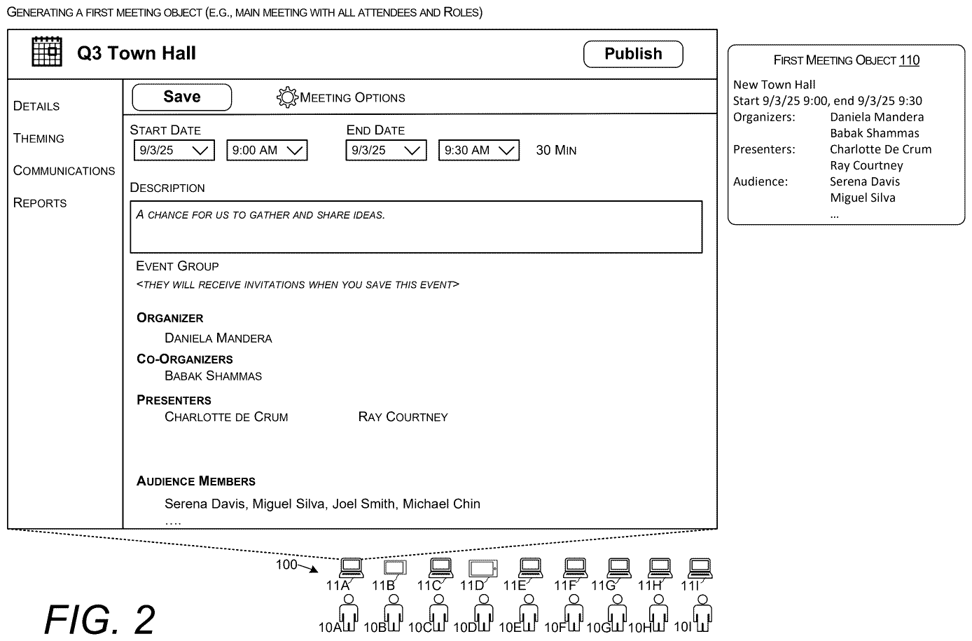

With reference to FIGS. 1 and 2, these figures show the state of the system where the system generates the first meeting object for the main meeting includes all attendees. This can be done by the use of a meeting organizer's user interface, which in this example is the first user 10A. In response to the first user populating the interface with roles and attendee names, and saving those changes, as shown in FIG. 1, the system generates the first meeting object 110 defining permissions of the communication session for the plurality of users, which includes Users 10A-10I. As shown in FIG. 2, the first meeting object 110 defines roles and identities of individual users of the plurality of users 10A-10I. The first meeting object 110 also includes permissions that allow the plurality of users 10A-10I to communicate messages with a first message thread, which is referred to herein as a meeting chat thread.

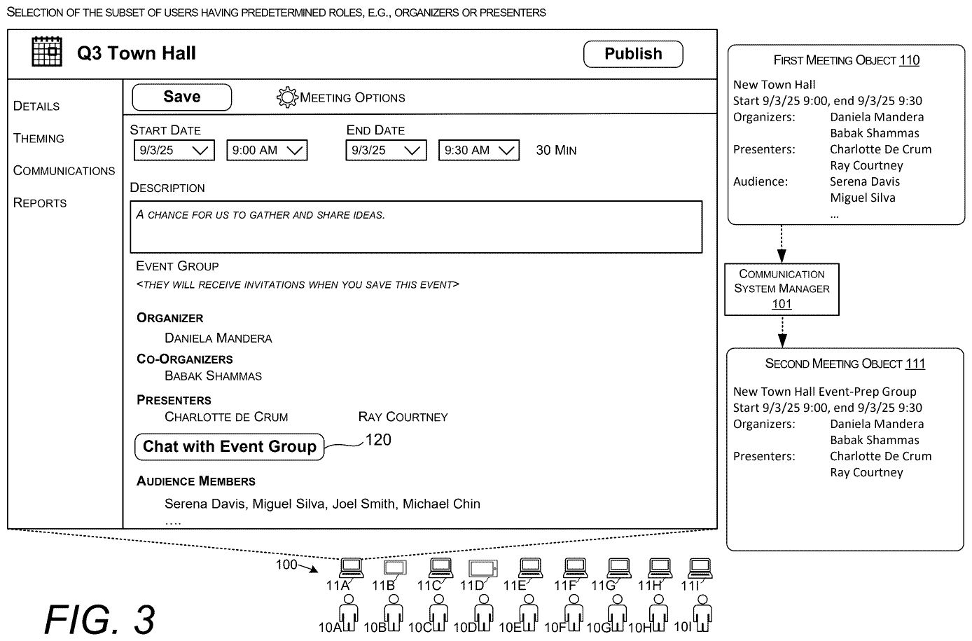

Next, as shown in FIG. 3, a communication system manager 101 of the system 100 generates a second meeting object 111 from the first meeting object 110. In the generation of the second meeting object 111, the system selects the identities of users having particular roles, e.g., presenters and organizers, for the event-prep group. In this example, it is given that presenters and organizers are selected for the event-prep group. Other specified roles can be used for selecting the subset of users.

The system selects a subset of users 10A-10D from the plurality of users 10A-101, wherein individual users of the subset of users 10A-10D are selected based on the individual users having predetermined roles defined in the first meeting object 110. Then, in response to the selection of the subset of users having the predetermined roles in the first meeting object, the system generates the second meeting object 111. As shown, the event-prep meeting object, e.g., the second meeting object 111 only includes users having particular roles, e.g., presenters and organizers, that were in the main meeting. This can include operations for generating the second meeting object 111 using the first meeting object 110, the second meeting object 111 including the subset of users having the predetermined roles. This also includes setting permissions for the second meeting object, where the second meeting object 111 includes permissions that allow the subset of users 10A-10D to communicate messages with a second message thread, e.g., the event-prep thread. The permissions also restrict other devices 11E-11I of the others 10E-10I, e.g., the users that are not in the subset of users 10A-10D, from communicating with the second message thread, or displaying messages of the second message thread.

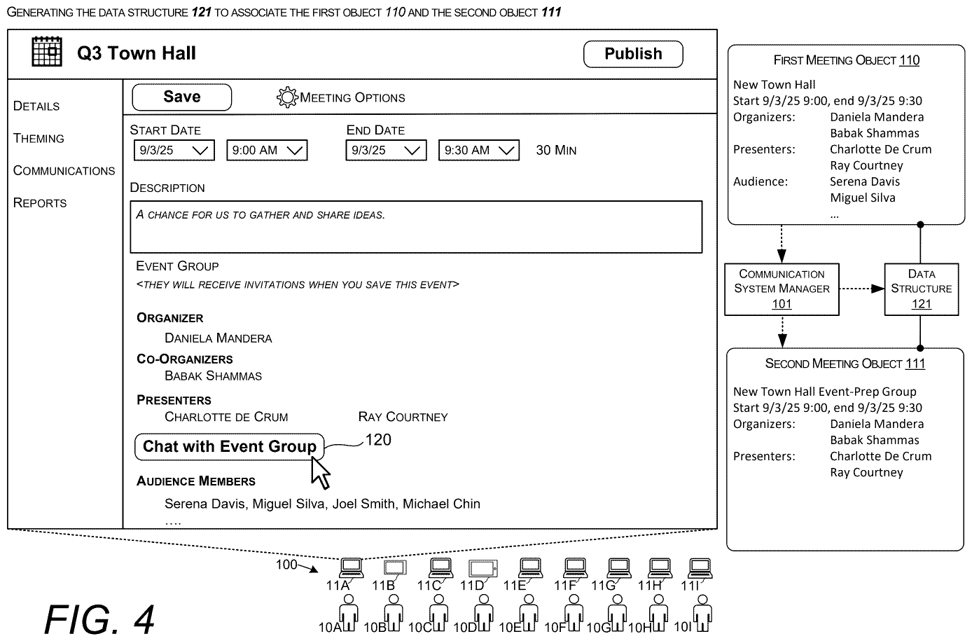

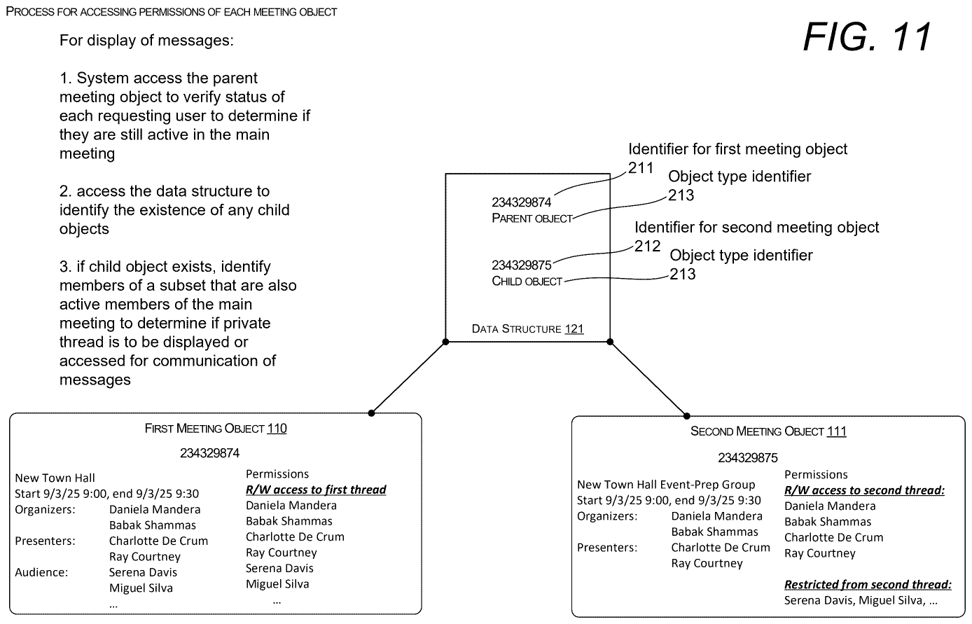

As shown in FIG. 4, the system also generates a data structure 121 that associates the event meeting object (the first meeting object) with the prep-group meeting object (the second meeting object). As described in more detail below, the data structure is utilized by the system to control access to the threads of each meeting object and to control the display of each thread for individual users. In the generation of the data structure, the system generates an identifier for the first meeting object, an identifier for the second meeting object, and object type identifiers. Further details on these identifiers are described below with respect to FIG. 11.

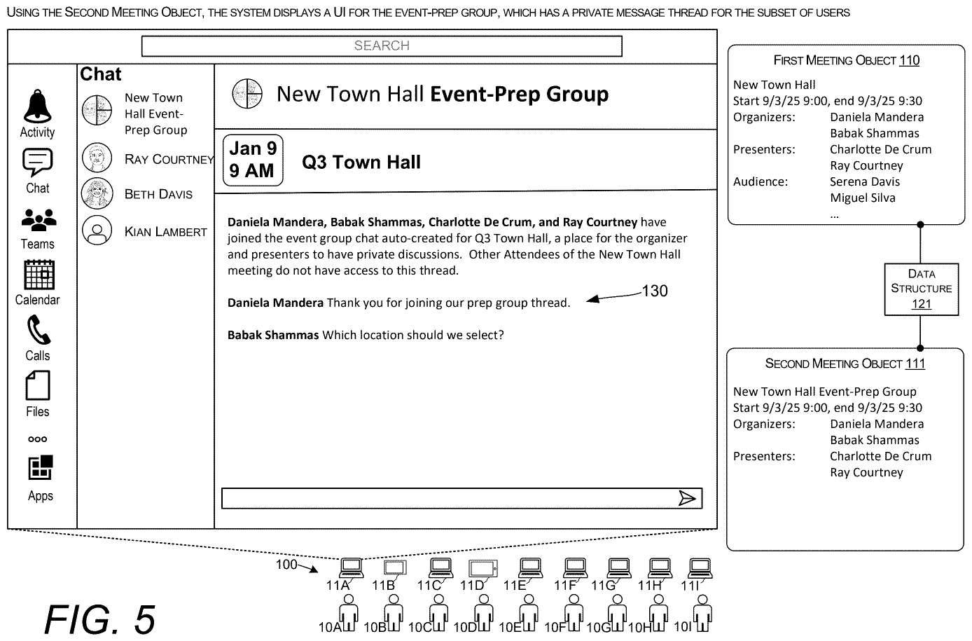

As shown in FIG. 5, the system generates a UI for the event-prep group chat thread, where access to the thread only allows the subset of users to view the event-prep group chat thread, e.g., the second message thread. The other users, who are not in the subset of users, are restricted from viewing the event-prep message thread, the second message thread. This includes operations for causing a display of the messages 130 of the second message thread on a subset of devices 11A-11D associated with the subset of users 10A-10D according to the permissions of the second meeting object 111.

As described in more detail below with respect to FIG. 11, the subset of devices 11A-11D utilize the data structure 121 to access the second meeting object 111, and the display of the messages 130 of the second message thread 130 are restricted from display on the other devices 11E-11I of the other users 10E-10I that are not in the subset of users 10A-10D. The display shown in FIG. 5 would be the same for any of the users that are members of the subset of users. In this specific example, the UI is the display that is displayed on the first device 11A of the first user 10A.

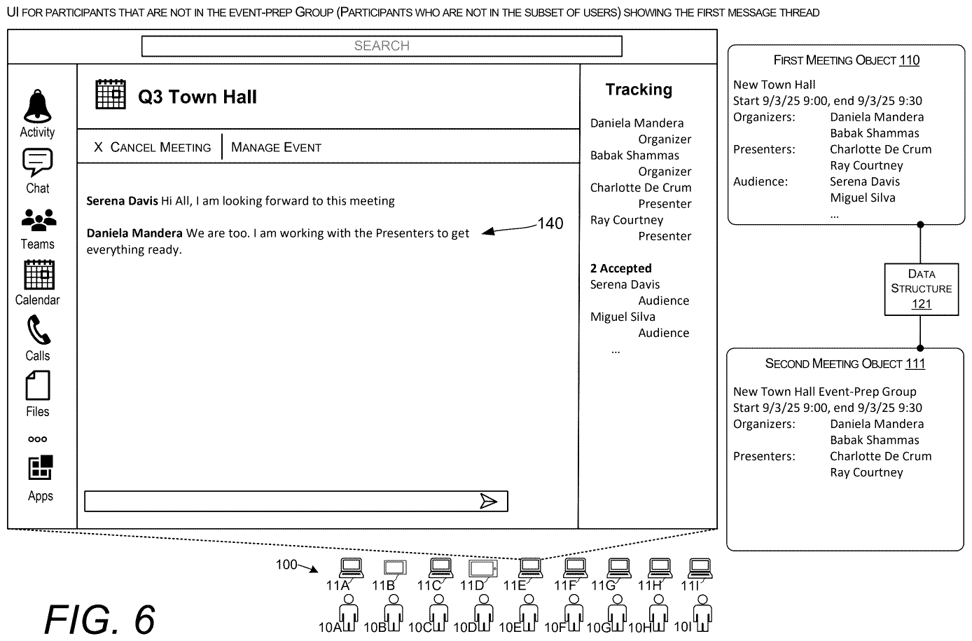

FIG. 6 shows an example of the UI that is displayed to users who are not in the subset of users. In this particular example, the UI is displayed on the fifth device 11E of the fifth user 10E. This shows the meeting chat thread, e.g., the first message thread 140 that is managed by the event meeting object. In this example, the user of the fifth device 11E, and other users that are not in the subset of users, are restricted from access to the second thread, the second thread reserved exclusively for the event-prep group.

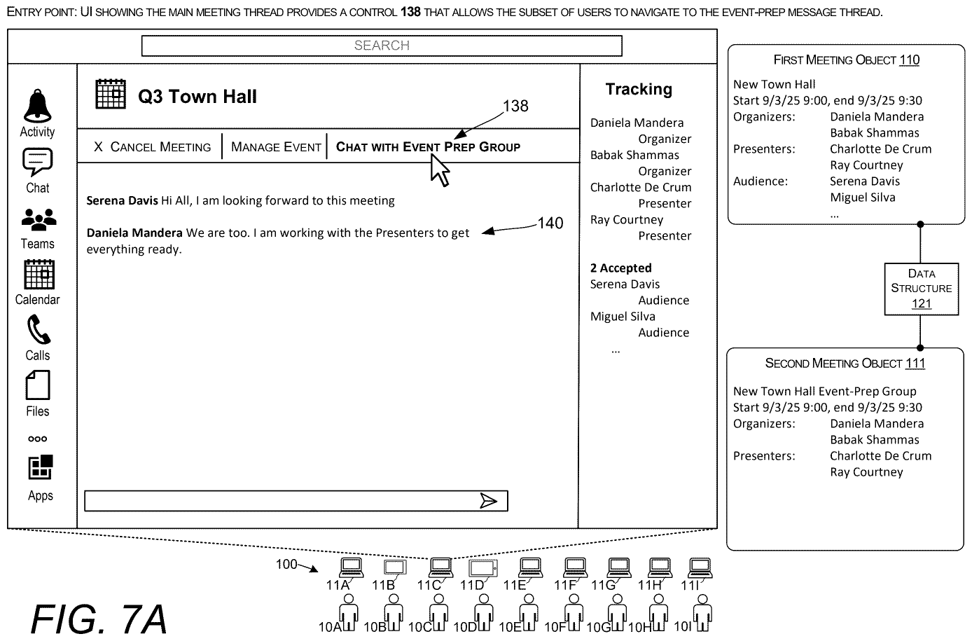

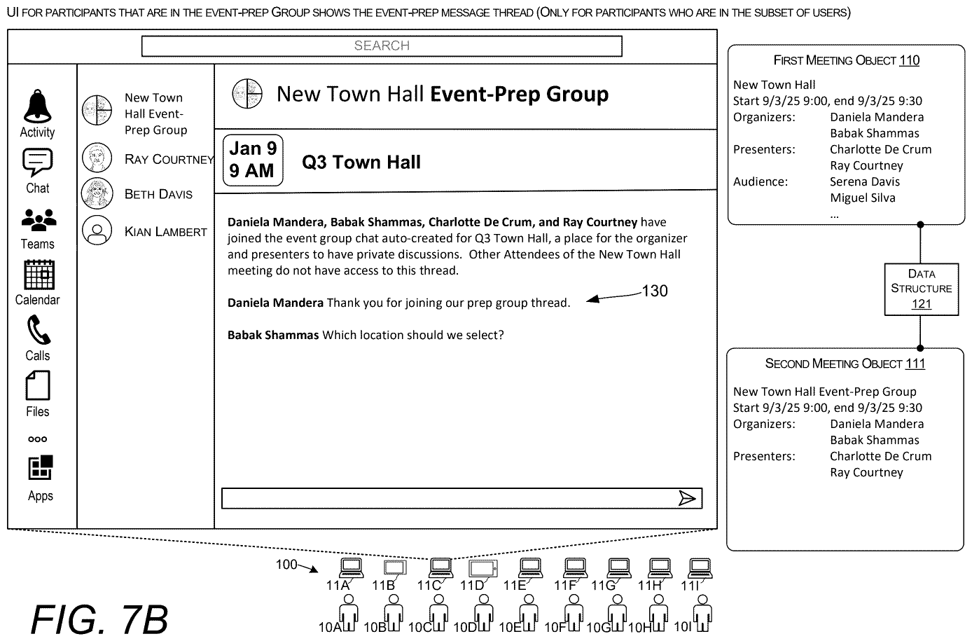

FIG. 7A shows an example of the UI that is displayed to the subset of users. In this particular example, the UI is displayed on the third device 11C of the third user 10C. This shows the meeting chat thread, e.g., the first message thread 140 that is managed by the event meeting object, the first meeting object. The UI of FIG. 7A is similar to the UI shown in FIG. 6 except the UI displayed to the subset of users includes a user interface element 138 that causes the display of the second message thread. In this example, in response to the selection of the user interface element 138, the system causes the display of the user interface shown in FIG. 7B, which shows a display of a UI that includes the second message thread. This feature shows one access point to the second message thread which is directly accessible from the meeting user interface.

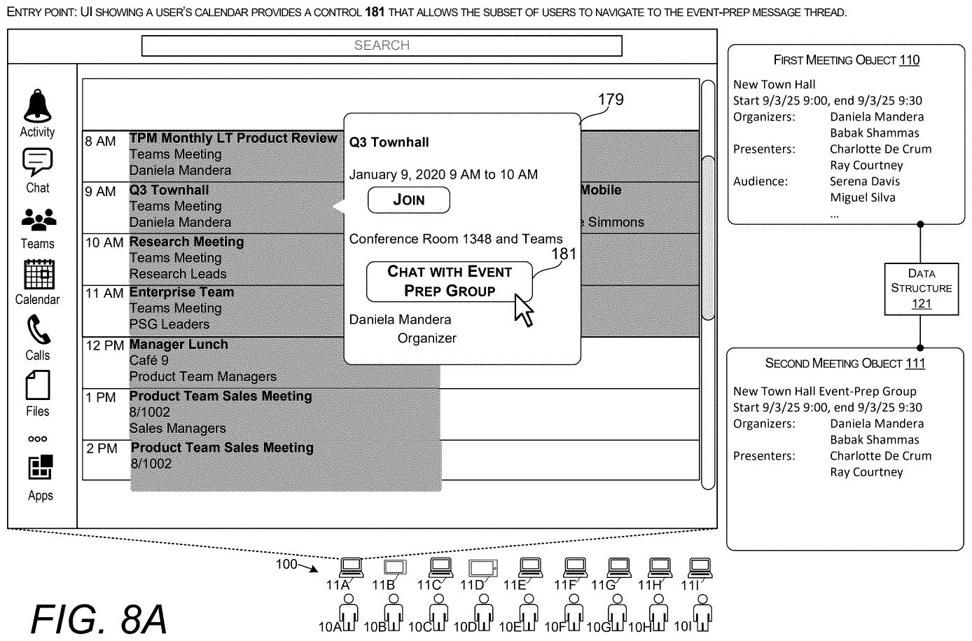

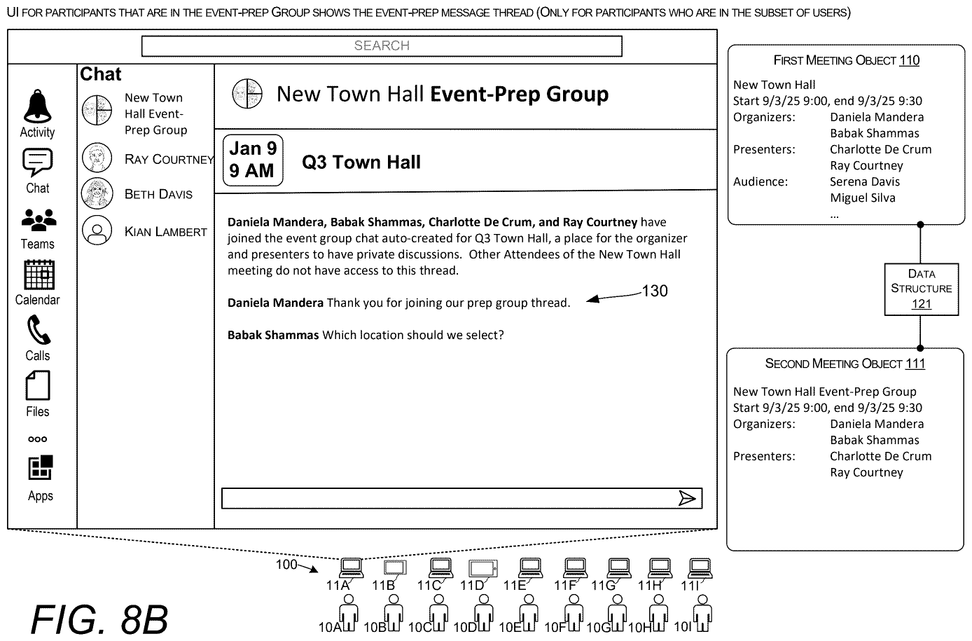

FIG. 8A shows a UI that is displayed to one of the users of the subset of users. This is an example of a calendar view for the first user 10A. When a user interacts with a calendar event, such as the Q3 Town Hall Meeting, e.g., by use of a hover or mouse selection, the System causes the display of a menu 179 that allows that user to join that meeting. Also shown, the menu also includes a button 181 that enables the subset of users to access a display of the second message thread of the second meeting object. This is a feature that is only accessible by the subset of users. Other users who are not a member of the subset of users only see the menu 179 but do not see the button 181 that accesses the second message thread. In response to the selection of the button 181, the system causes the display of the user interface shown in FIG. 8B, which shows a display of a UI that includes the second message thread 130. This example shows one more access point to the second message thread which allows organizers to readily access the event-prep message thread without having to conduct a search for a private chat with the subset of users.

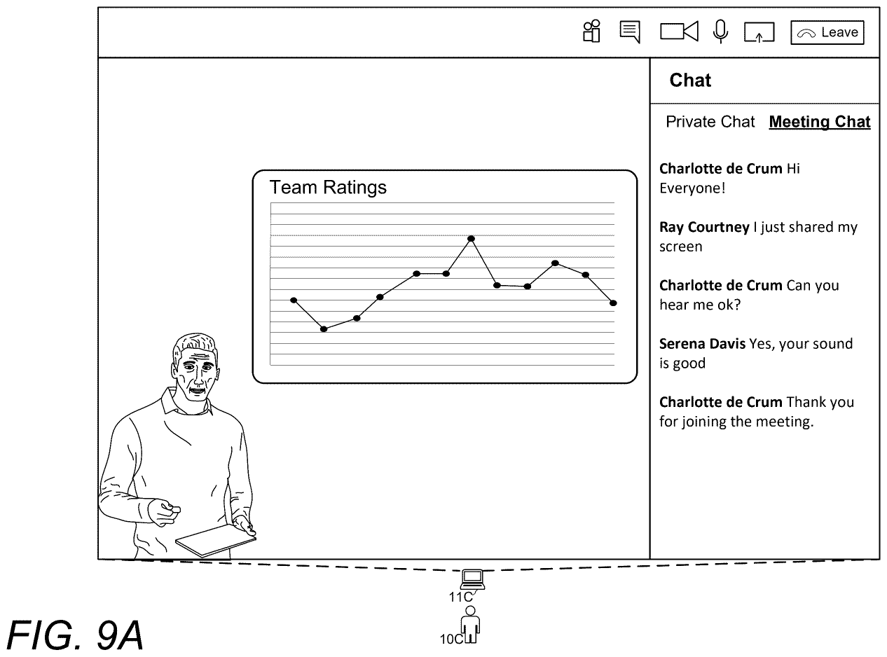

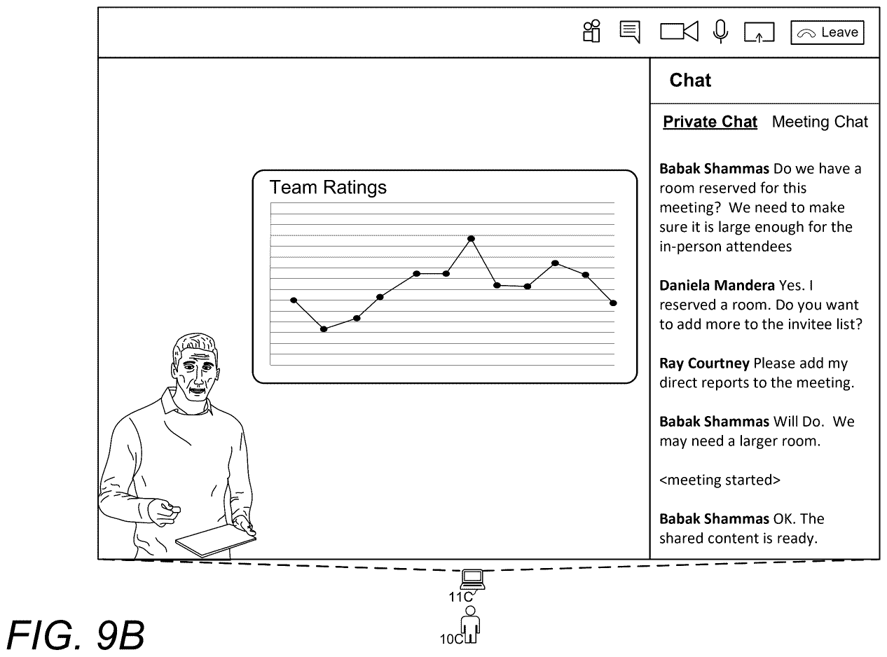

FIGS. 9A and 9B show examples of a UI that is displayed exclusively to the subset of users during the meeting, e.g., after the start time and before the end time of the meeting managed by the first meeting object. This is an example of a user interface that provides an entry point to the event-prep message thread during the meeting. The system can provide a user interface having a tabbed view: a first tab shown in FIG. 9A where a UI shows the meeting chat thread, and a second tab shown in FIG. 9B where a UI shows the event-prep message thread that is only accessible by the subset of users. The UI shows the tabs for the main meeting thread and the event-prep message thread, which is displayed concurrently with content that is presented as meeting content.

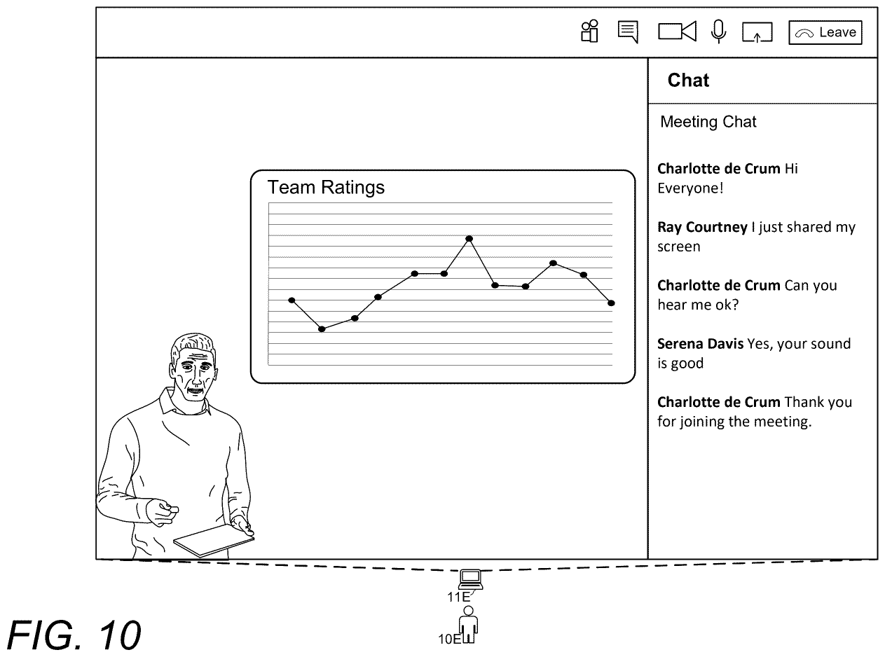

FIG. 10 shows an example of a user interface that is displayed to users who are not in the subset of users during the meeting. As shown, the system restricts access to the tab view of the main meeting thread (“the first message thread”) and the event-prep message thread (“the first message thread”). The system does not provide an access point to the event-prep message thread. Instead, for the other users outside the subset, a UI shows the main meeting thread that is concurrently displayed with shared content.

Turning now to FIG. 11, aspects of the data structure are shown and described below. In some configurations, the system utilizes the data structure for controlling permissions of select users for access to the main meeting thread (“the first message thread”) and the event-prep message thread (“the first message thread”). In general, a device of a user sends a request to access a thread, the system first checks the permissions of the main meeting object (“the first meeting object 110”). The system checks the main meeting object for each request because each person is associated with the main meeting. The system then determines if the main meeting object is associated with a data structure 121. This can be done by the use of the identifier 211 of the main meeting object stored within the main meeting object and the data structure 121.

The existence of the data structure 121 indicates that the meeting is associated with an event prep group. If the data structure does not exist, that indicates that the event-prep meeting object (“the second meeting object 111”) does not exist, and the system proceeds to operations where the system only displays the first message thread to the device of the requesting user. However, if the system determines the existence of the data structure, the system obtains the identifier for the second meeting object 212. Using the identifier for the second meeting object 212, the system obtains the identities and permissions for the subset of users. The system can also use one of the object type identifiers to determine if the event-prep meeting object exists, active or valid.

In some embodiments, the system also uses the meeting objects to determine if a user is still an active member of a meeting before messages are communicated or displayed. A process can include operations for accessing the first meeting object to verify a status of a user 10E (who is not in the subset of users) requesting access to the messages of the first message thread or messages of the second message thread. A status can include an active status for a person who is currently listed as an invitee or a person who accepted an invitation, and an inactive status can include a person who denied an invitation or a person who was removed from the attendee list. If a person is inactive, the process can terminate and access to a thread for that person is denied. In response to determining that the status of the user 10E is active for the first meeting object, the system can determine that the data structure is associated with the first meeting object. In response to determining that the data structure is associated with the first meeting object, obtain the identifier for the second meeting object. Then, using the identifier for the second meeting object, the system accesses the second meeting object and determines that the permissions in the second meeting object restrict the user 10E to access the messages of the second message thread if the user is an active member of the first meeting object and if the user is not in the subset of users defined in the second meeting object. The messages of the second message thread are not displayed or communicated and that user 10E, and the device of the user cannot communicate messages with the second message thread.

In another example, which involves a user 10A that is part of a subset, the system accesses the first meeting object to verify a status of the user 10A requesting access to the messages of the first message thread or messages of the second message thread. In response to determining that the status of the user 10A is active for the first meeting object, determine that the data structure is associated with the first meeting object. In response to determining that the data structure is associated with the first meeting object, the system obtains the identifier for the second meeting object. Using the identifier for the second meeting object, the system then accesses the second meeting object and determines that the user is in the subset via the permissions in the second meeting object that allow the user 10A to access the messages of the second message thread. The system then allows the user 10A to access the messages of the second message thread if the user is an active member of the first meeting object and if the user is an active member of the subset of users defined in the second meeting object.

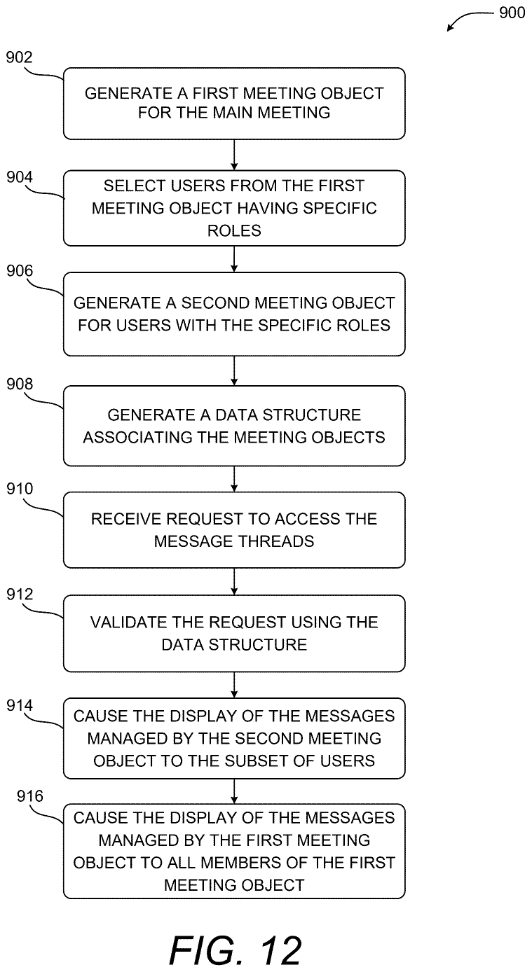

Turning now to FIG. 12, aspects of a routine 900 for providing event group collaboration sessions for meeting organizers are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an NLP algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the position or state of any device may be used in operations described herein.

The routine starts at operation 902, where the system generates a first meeting object for the main meeting. As shown in FIGS. 1 and 2, the system can generate the meeting object the main meeting includes all attendees. This can be caused by an input that defines meeting parameters, e.g., a name, start time, end time, and attendee and roles for each attendee. The system can generate the first meeting object 110 defining permissions of the communication session for the plurality of users, the first meeting object 110 defining roles for identities of individual users of the plurality of users 10A-10I, the first meeting object 110 including permissions that allow the plurality of users 10A-10I to communicate messages with a first message thread.

At operation 904, the system selects users from the first meeting object having specific roles. As shown in FIG. 3, the system can select identities of users having particular roles, e.g., presenters and organizers, for the event-prep group. This can include operations for selecting a subset of users 10A-10D from the plurality of users 10A-101, wherein individual users of the subset of users 10A-10D are selected based on the individual users having predetermined roles defined in the first meeting object 110.

At operation 906, the system generates a second meeting object for users with the specific roles. Also shown in FIG. 3, the system can generate an event-prep meeting object “second meeting object 111” only for users having particular roles, e.g., presenters and organizers, where those roles are defined in the main meeting are selected for the event-prep meeting object. This can include generating the second meeting object 111 using the first meeting object 110, the second meeting object 111 including the subset of users having the predetermined roles. The second meeting object 111 includes permissions that allow the subset of users 10A-10D to communicate messages with a second message thread. The permissions restrict other devices 11E-11I of the others 10E-10I that are not in the subset of users 10A-10D from communicating with the second message thread 130.

At operation 908, the system generates a data structure associating the meeting objects. This can include the generation of a data structure shown in FIG. 11, where the data structure includes identifiers for each meeting object and meeting type identifies, e.g., the main meeting being the parent object and the prep-group meeting being a child object.

At operation 910, the system receives a request to access the message threads. This can include the start of a communication application such as Teams by a particular user and the application is to display message threads available to that user. A request can include a request to display one or more message threads or a request to communicate (send and received) messages with a particular thread.

At operation 912, the system validates the request using the data structure. As described above with respect to FIG. 11, the system can determine if a requesting user, is an active member of the main meeting, and if so, determine if they are a member of a subset defined in a child meeting object. If so, such users can display messages of an event-prep group message thread, or communicate message with that event-prep group message thread.

At operation 914, the system causes the display of the messages managed by the second meeting object to the subset of users. An example of a UI showing the messages managed by the second meeting object are shown in FIGS. 5, 7B, 8B and 9B. These messages are restricted from display on the devices of users that are not in the subset of users.

At operation 916, the system causes the display of the messages managed by the first meeting object to all members of the first meeting object. Examples of a UI showing the messages managed by the first meeting object are shown in FIGS. 6 and 10. These messages can also be displayed to users of the subset. This is shown in the example UIs of FIGS. 7A and 9A.

For illustrative purposes, consider the following definitions. The first private message thread is the chat modality thread or a “chat modality private thread.” The second private message thread is the meeting modality thread or a “meeting modality private thread.” The public message thread is displayed in the meeting modality.

A communication object defines permissions for a set of participants of the first private message thread. The permissions of the communication object allow or restrict communication of messages between the participants. The permissions of the communication object do not define permissions for sharing live video or live audio between the participants. The communication object is not associated with a meeting and is not associated with a designed start time or stop time. The communication object allows a set of participants of the first private message thread to display messages of the first private message thread in a user interface that is independent of a UI that displays meeting properties. Meeting properties include a start time of a meeting, an end time of a meeting, an attendee list for the meeting, etc.

When an application is operating in chat modality, the system utilizes a communication object to control the display and communication of messages between a set of users listed in the communication object. User interfaces displayed in the chat modality can communicate private messages using a private message thread between users listed in the communication object. The private message threads can have a lifecycle that is not bound to a start time or an end time of a meeting. Thus, participants named in a private message thread that is initiated while an application is in chat modality, can freely communicate messages on the thread without being restricted to sharing messages with a start time of a meeting and an end time of a meeting. The private message thread controlled by the communication object is not required to be displayed with one or more attributes of a meeting, e.g., a start time of a meeting, an end time of a meeting and permissions and roles of the participants. When a device displays a user interface displaying a private message thread shared between the set of participants listed in the communication object, and the user interface is displayed using the communication object and is independently displayed from a user interface displaying attributes of a meeting, that device and its associated software application are defined as operating in a chat modality.

A meeting object defines permissions, roles, and other meeting attributes for participants of a meeting. The permissions allow or restrict live video and/or audio communication between the participants. The permissions allow or restrict communication of content between the participants. The permissions allow or restrict communication of messages between the participants using a meeting chat thread that is only displayed in conjunction with the display of at least one of permissions, roles, and attributes of a meeting. The attributes of a meeting include a start time of a meeting, an end time of a meeting and permissions, and roles of the participants. The meeting object is associated with a meeting and is associated with a designed start time or stop time. The meeting object allows set of participants of the private message thread (“referred to herein as a second private message thread”) to display messages of the private message thread in a user interface that displays meeting attributes. The private message thread controlled by the meeting object only allows the communication of messages between a subset of users that are selected from the list of participants of the meeting.

When an application is operating in a meeting modality, the system utilizes a meeting object to control the display and communication of messages, shared files, live video streams, and live audio streams between a set of users listed in the meeting object. User interfaces displayed in the meeting modality can communicate private messages using a private message thread between users listed in the meeting object. The private message thread controlled by the meeting object is displayed concurrently with at least one meeting attribute, and in some embodiments, the private message thread controlled by the meeting object requires the display or communication of at least one meeting attribute with the display of the private message thread. The meeting attribute can include shared video streams, shared audio streams or a shared file. When a device displays a user interface displaying a private message thread shared between a subset of users listed in the meeting object, and the user interface is displayed using the meeting object during a meeting, that device and its associated software application are defined as operating in a meeting modality. A “thread” described herein can also include email threads, instant messaging threads, text messages, etc. some embodiments are only focused on a single platform, such as a message thread within a communication program such as MS TEAMS, Google Hangouts, Facebook Messager, etc.

FIG. 5 shows a user interface that is displayed in the chat modality, where the system uses the first meeting object, which is also referred to herein as an event-prep object, to display the user interface. Since this interface is limited to the display of the set of users defined in the first meeting object 110, it does not allow the other users of the meeting to display the user interface. In addition, in chat modality, aspects of the meeting, such as shared video and audio streams for the meeting are restricted from display.

FIG. 9B shows a user interface that is displayed in the meeting modality, where the system uses the second meeting object to display the user interface. This interface is open to all members of the meeting but the private chat is limited to the display of the set of users defined in the private chat thread of the second meeting object 111. The system does not allow the other users of the meeting outside the private chat group to display the private chat thread. In addition, in meeting modality, aspects of the meeting, such as shared video and audio streams for the meeting are allowed for display to all users.

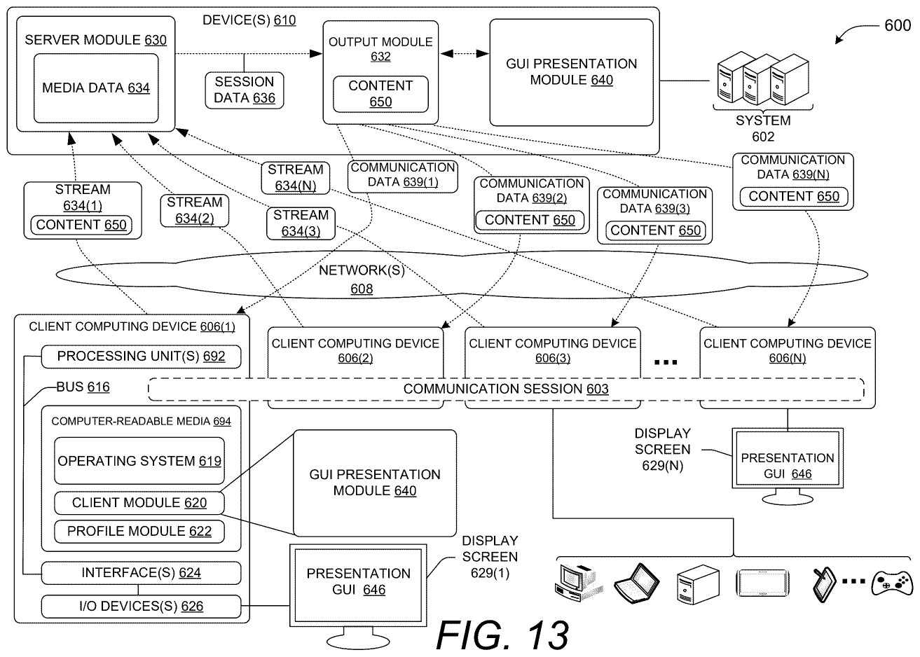

FIG. 13 is a diagram illustrating an example environment 600 in which a system 602 can implement the techniques disclosed herein. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, the system 602 may function to collect, analyze, and share data that is displayed to users of a communication session 604. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 13 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 13 illustrates that client computing device 606(1) is in some way connected to a display device (e.g., a display screen 629(N)), which can display a UI according to the techniques described herein.

In the example environment 600 of FIG. 13, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 13) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 13, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603. The server module 630 can function as the communication system manager 101 that manages access to the threads, meeting object and the data structures, as described herein.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a display of a message thread or contain content for communicating messages with a thread. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

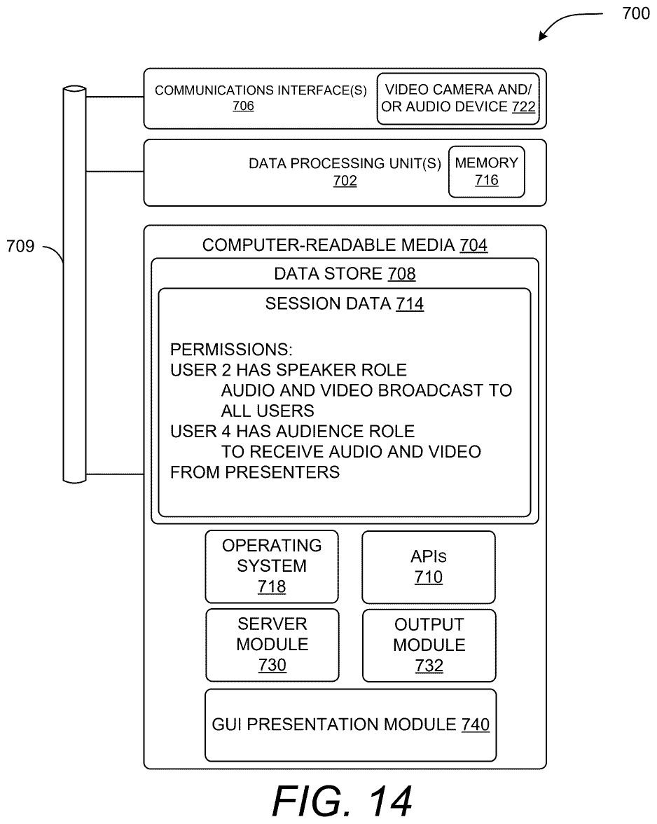

FIG. 14 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic devices (“CPLDS”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface 7 controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store session data 710 (e.g., session data 636 as shown in FIG. 13), profile data (e.g., associated with a participant profile), and/or other data. The session data 710 can include a total number of participants (e.g., users and/or client computing devices) in a communication session, activity that occurs in the communication session, a list of invitees to the communication session, and/or other data related to when and how the communication session is conducted or hosted. The data store 708 may also include session data 714, such as the content that includes video, audio, or other content that can be shared in a chat thread. This the session data 714 can also include permissions for each user. For example, a role of a designated presenter can be granted to User 2 and User 4 can have an audience role.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter. We claim:

1. A method, executed by a computing system, for controlling permissions for a first meeting object and a second meeting object, wherein the first meeting object is used for managing access of a first communication session and the second meeting object is generated from information included in the first meeting object, the method comprising:
according to a meeting invite for the first communication session including a plurality of users, generating the first meeting object defining roles for at least some of the plurality of users;
selecting a subset of users from the plurality of users, based on the individual users having one or more predetermined roles defined in the first meeting object;
in response to the selection of the subset of users having the predetermined roles in the first meeting object:
generating the second meeting object including the subset of users having the predetermined roles, the second meeting object including permissions that allow the subset of users to communicate messages with a second message thread, the permissions restricting other devices of the others that are not in the subset of users from communicating with the second message thread, and
generating a data structure associating the second meeting object with the first meeting object;
causing a display of the messages of the second message thread in a chat user interface on devices associated with the subset of users according to the permissions of the second meeting object; and
during the first communication session:
accessing the data structure;
according to the data structure, causing a display of the messages of the second message thread in a meeting user interface of the first communication session on the devices associated with the subset of users, but not in the meeting user interface of the first communication session on the other devices of the other users that are not in the subset of users, wherein the chat user interface is not part of the meeting user interface.

2. The method of claim 1, further comprising:
accessing the first meeting object including permissions that allow the plurality of users to communicate messages with a first message thread; and
causing a display of the messages of the first message thread on the other devices of the other users that are not in the subset of users, the display of the messages of the first message thread on the other devices permitted by the permissions that allow the plurality of users, including the other users that are not in the subset of users, to communicate messages with the first message thread, wherein permissions to communicate messages with the first message thread includes permissions to add messages to first message thread and permissions to receive message that are in the first message thread.

3. The method of claim 1, further comprising:
causing a display of the messages of the first message thread on a device of a user that is included in the subset of users, the display of the messages include messages that are arranged in a meeting user interface that concurrently shows properties of the first communication session, the meeting user interface including a selectable UI element for initiating a display of the second message thread;
in response to receiving an input at the selectable UI element, determining that the user is included in the subset of users; and
in response to determining that the user is included in the subset of users, causing the display of the messages of the second message thread on the device of the user, wherein the second message thread is not displayed if the user is not included in the subset of users.

4. The method of claim 1, further comprising:
displaying user interface comprising a calendar for a user on a device of the user that is included in the subset of users, the display of the calendar concurrently displayed with a selectable UI element for initiating a display of the second message thread;
in response to receiving an input at the selectable UI element, determining that the user is included in the subset of users; and
in response to determining that the user is included in the subset of users, causing the display of the messages of the second message thread on the device of the user, wherein the second message thread is not displayed if the user is not included in the subset of users.

5. The method of claim 1, wherein the display of the messages of the second message thread on a subset of devices includes a user interface arrangement having two tabs: a first tab for displaying the second message thread and a second tab for displaying a first message thread managed by the first meeting object, a selection of the first tab causes the display of the second message thread while removing the first message thread from the display, and selection of the second tab causes the display of the first message thread while removing the second message thread from the display.

6. The method of claim 1, wherein the chat user interface is displayed in a chat modality utilizing the first meeting object, wherein the meeting user interface is display in a meeting modality utilizing the second meeting object, the meeting user interface displaying at least one other meeting attribute that includes at least one of shared video streams, shared audio streams or a shared file.

7. The method of claim 1, wherein the utilizing the data structure to access the second meeting object, comprises:
accessing the first meeting object to verify a status of a user requesting access to the messages of the first message thread or messages of the second message thread;
in response to determining that the status of the user is active for the first meeting object, determine that the data structure is associated with the first meeting object;
in response to determining that the data structure is associated with the first meeting object, obtain the identifier for the second meeting object;
using the identifier for the second meeting object to access the second meeting object and determine that the permissions in the second meeting object to allow the user to access the messages of the second message thread, wherein the system allows the user to access the messages of the second message thread if the user is an active member of the first meeting object and if the user is an active member of the subset of users defined in the second meeting object.

8. The method of claim 1, wherein the utilizing the data structure to access the second meeting object, comprises:
accessing the first meeting object to verify a status of a user requesting access to the messages of the first message thread or messages of the second message thread;
in response to determining that the status of the user is active for the first meeting object, determine that the data structure is associated with the first meeting object;
in response to determining that the data structure is associated with the first meeting object, obtain the identifier for the second meeting object;
using the identifier for the second meeting object to access the second meeting object and determine that the permissions in the second meeting object restrict the user from accessing the messages of the second message thread if the user is an active member of the first meeting object and if the user is not in the subset of users defined in the second meeting object.

9. A computing system for controlling permissions for a first meeting object and a second meeting object, wherein the first meeting object is used for managing access of a first communication session and the second meeting object is used for managing access of a second communication session, wherein the second meeting object is generated from the first meeting object, the computing system comprising:
one or more processing units; and
a computer-readable storage medium having encoded thereon computer-executable instructions to cause the one or more processing units to:
generate the first meeting object defining permissions of the communication session for the plurality of users, the first meeting object defining roles for identities of individual users of the plurality of users, the first meeting object including permissions that allow the plurality of users to communicate messages with a first message thread;
select a subset of users from the plurality of users, wherein individual users of the subset of users are selected based on the individual users having predetermined roles defined in the first meeting object;
in response to the selection of the subset of users having the predetermined roles in the first meeting object:
generate the second meeting object using the first meeting object, the second meeting object including the subset of users having the predetermined roles, the second meeting object including permissions that allow the subset of users to communicate messages with a second message thread, the permissions restricting other devices of the others that are not in the subset of users from communicating with the second message thread, and
generate a data structure associating the second meeting object with the first meeting object; and
cause a display of the messages of the second message thread on a subset of devices associated with the subset of users according to the permissions of the second meeting object, wherein the subset of devices utilize the data structure to access the second meeting object, wherein the display of the messages of the second message thread are restricted from display on the other devices of the other users that are not in the subset of users.

10. The computing system of claim 9, wherein the instructions further cause the one or more processing units to:
access the first meeting object including permissions that allow the plurality of users to communicate messages with a first message thread; and
cause a display of the messages of the first message thread on the other devices of the other users that are not in the subset of users, the display of the messages of the first message thread on the other devices permitted by the permissions that allow the plurality of users, including the other users that are not in the subset of users, to communicate messages with the first message thread, wherein permissions to communicate messages with the first message thread includes permissions to add messages to first message thread and permissions to receive message that are in the first message thread.

11. The computing system of claim 9, wherein the instructions further cause the one or more processing units to:
cause a display of the messages of the first message thread on a device of a user that is included in the subset of users, the display of the messages include messages that are arranged in a meeting user interface that concurrently shows properties of the first communication session, the meeting user interface including a selectable UI element for initiating a display of the second message thread;
in response to receiving an input at the selectable UI element, determine that the user is included in the subset of users; and
in response to determining that the user is included in the subset of users, cause the display of the messages of the second message thread on the device of the user, wherein the second message thread is not displayed if the user is not included in the subset of users.

12. The computing system of claim 9, wherein the instructions further cause the one or more processing units to:
display user interface comprising a calendar for a user on a device of the user that is included in the subset of users, the display of the calendar concurrently displayed with a selectable UI element for initiating a display of the second message thread;
in response to receiving an input at the selectable UI element, determine that the user is included in the subset of users; and
in response to determining that the user is included in the subset of users, cause the display of the messages of the second message thread on the device of the user, wherein the second message thread is not displayed if the user is not included in the subset of users.

13. The computing system of claim 9, wherein the display of the messages of the second message thread on a subset of devices includes a user interface arrangement having two tabs: a first tab for displaying the second message thread and a second tab for displaying a first message thread managed by the first meeting object, a selection of the first tab causes the display of the second message thread while removing the first message thread from the display, and selection of the second tab causes the display of the first message thread while removing the second message thread from the display.

14. The computing system of claim 9, wherein utilizing the data structure to access the second meeting object comprises:
accessing the first meeting object to verify a status of a user requesting access to the messages of the first message thread or messages of the second message thread;
in response to determining that the status of the user is active for the first meeting object, determine that the data structure is associated with the first meeting object, and identify the second meeting object;
using the permissions of the second meeting object to determine that the user is included in the subset of users; and
displaying the messages of the second message thread on the device of the user in response to determining that the user is included in the subset of users.

15. The computing system of claim 9, wherein utilizing the data structure to access the second meeting object, comprises:
accessing the first meeting object to verify a status of a user requesting access to the messages of the first message thread or messages of the second message thread;
in response to determining that the status of the user is active for the first meeting object, determine that the data structure is associated with the first meeting object;
in response to determining that the data structure is associated with the first meeting object, obtain the identifier for the second meeting object;
using the identifier for the second meeting object to access the second meeting object and determine that the permissions in the second meeting object to allow the user to access the messages of the second message thread, wherein the system allows the user to access the messages of the second message thread if the user is an active member of the first meeting object and if the user is an active member of the subset of users defined in the second meeting object.

16. A computer-readable storage medium having encoded thereon computer-executable instructions for controlling permissions for a first meeting object and a second meeting object, wherein the first meeting object is used for managing access of a first communication session and the second meeting object is used for managing access of a second communication session, wherein the second meeting object is generated from the first meeting object, the computer-executable instructions configured to cause one or more processing units of a computing system to:
generate the first meeting object defining permissions of the communication session for the plurality of users, the first meeting object defining roles for identities of individual users of the plurality of users, the first meeting object including permissions that allow the plurality of users to communicate messages with a first message thread;
select a subset of users from the plurality of users, wherein individual users of the subset of users are selected based on the individual users having predetermined roles defined in the first meeting object;
in response to the selection of the subset of users having the predetermined roles in the first meeting object:
generate the second meeting object using the first meeting object, the second meeting object including the subset of users having the predetermined roles, the second meeting object including permissions that allow the subset of users to communicate messages with a second message thread, the permissions restricting other devices of the others that are not in the subset of users from communicating with the second message thread, and
generate a data structure associating the second meeting object with the first meeting object; and
cause a display of the messages of the second message thread on a subset of devices associated with the subset of users according to the permissions of the second meeting object, wherein the subset of devices utilize the data structure to access the second meeting object, wherein the display of the messages of the second message thread are restricted from display on the other devices of the other users that are not in the subset of users.

17. The computer-readable storage medium system of claim 16, wherein the instructions further cause the one or more processing units to:
access the first meeting object including permissions that allow the plurality of users to communicate messages with a first message thread; and
cause a display of the messages of the first message thread on the other devices of the other users that are not in the subset of users, the display of the messages of the first message thread on the other devices permitted by the permissions that allow the plurality of users, including the other users that are not in the subset of users, to communicate messages with the first message thread, wherein permissions to communicate messages with the first message thread includes permissions to add messages to first message thread and permissions to receive message that are in the first message thread.

18. The computer-readable storage medium system of claim 16, wherein the instructions further cause the one or more processing units to:
cause a display of the messages of the first message thread on a device of a user that is included in the subset of users, the display of the messages include messages that are arranged in a meeting user interface that concurrently shows properties of the first communication session, the meeting user interface including a selectable UI element for initiating a display of the second message thread;
in response to receiving an input at the selectable UI element, determine that the user is included in the subset of users; and
in response to determining that the user is included in the subset of users, cause the display of the messages of the second message thread on the device of the user, wherein the second message thread is not displayed if the user is not included in the subset of users.

19. The computer-readable storage medium system of claim 16, wherein the instructions further cause the one or more processing units to:
display user interface comprising a calendar for a user on a device of the user that is included in the subset of users, the display of the calendar concurrently displayed with a selectable UI element for initiating a display of the second message thread;
in response to receiving an input at the selectable UI element, determine that the user is included in the subset of users; and
in response to determining that the user is included in the subset of users, cause the display of the messages of the second message thread on the device of the user, wherein the second message thread is not displayed if the user is not included in the subset of users.

20. The computer-readable storage medium system of claim 16, wherein the display of the messages of the second message thread on a subset of devices includes a user interface arrangement having two tabs: a first tab for displaying the second message thread and a second tab for displaying a first message thread managed by the first meeting object, a selection of the first tab causes the display of the second message thread while removing the first message thread from the display, and selection of the second tab causes the display of the first message thread while removing the second message thread from the display.
